(19) United States
(12) Patent Application Publication
(10) Pub. No.: US 2016/0025575 A1
(43) Pub. Date: Jan. 28, 2016

(54) Adapter for Measuring a Physical Variable

(71) Applicant: WIKA Alexander Wiegand SE & Co. KG, Klingenberg (DE)

(72) Inventors: Patrick Schork, Luetzelbach (DE); Juergen Braeutigam, Elsenfeld (DE); Andreas Loebig, Klingenberg (DE)

(21) Appl. No.: 14/811,724

(22) Filed: Jul. 28, 2015

(30) Foreign Application Priority Data
Jul. 28, 2014 (DE) 102014110629.6

(51) Int. Cl. G01K 7/02; B23P 11/02; G01K 13/00

(52) U.S. Cl. CPC G01K 7/023; G01K 13/00; B23P 11/025

(57) ABSTRACT

An adapter (1) is proposed for measuring a physical state variable of a medium in a system (15) by means of a sensor. The adapter (1) has a descender tube closed towards the medium (2) which can be inserted into the medium through an opening (5) and contains the sensor and a flange plate (3) having a central recess and that can be sealingly connected with a connecting flange (5A). The descender tube (2) is sealingly fitted in the flange plate (3). The sealing fitting of the descender tube (2) in the flange plate (3) results from a temperature difference being established between the descender tube (2) and the flange plate (3), wherein the descender tube (2) is inserted into the flange plate (3), and then temperature equilibrium established between the descender tube (2) and the flange plate (3) in order to obtain a sealing press-fit connection between the descender tube (2) and the flange plate (3). The production of such an adapter is less complex and faster than with welding. Almost any material combinations are possible. Since no welding occurs, the welding procedure test and subsequent post-processing may be dispensed with.

### FIELD OF THE INVENTION

The invention relates to an adapter for measuring a physical state variable of a medium in a system using a sensor, as well as a method for joining such an adapter.

### STATE OF THE ART

Adapters of the above-mentioned type typically consist of a descender tube to accommodate the sensor and a sealing flange plate which serves to connect the adapter to the system. The sealing connection between the descender tube and the flange plate is achieved by various welding methods, e.g. by so-called “full penetration welding”.

However, these methods present a number of shortcomings and disadvantages. It is, for example, impossible to connect stainless steel with materials such as titanium or zirconium by welding, so that certain material combinations are excluded from the outset. In addition, depending on the material and the thickness of the flange, the connection of the descender tube and the flange plate by welding requires a considerable amount of time, which may range from about 20 minutes to several hours. The high temperatures that can be reached thereby, can lead to distortion of the descender tube or the flange plate. In addition, there may be lack of fusion that requires time-consuming reworking of the weld. Moreover, when using certain materials, further heat treatment is required in an oven, which causes very high expenditure in time and costs.

### OBJECT

The object of the invention is to improve upon the prior art in the production of adapters of the type mentioned and to minimise the disadvantages mentioned.

### SOLUTION

This object is solved by the invention with the characteristics of the independent claims. Advantageous developments of the invention are characterised in the dependent claims. The wording of all the claims is hereby incorporated into this description by reference.

To solve the object, an adapter is provided for measuring a physical state variable of a medium in a system using a sensor. The system has an opening with a connection flange for closing the opening, wherein the connection flange has a central recess. The adapter has a descender tube closed towards the medium, and which is so designed that it can be inserted into the medium through the central recess and the opening and has an opening on the side facing away from the medium through which it can receive the sensor in its interior. In addition, the adapter has a flange plate which has a central recess and which can be sealingly connected to the connection flange. The descender tube is sealingly fitted into the flange plate.

According to the invention, the sealing fitting of the descender tube in the flange plate is characterised in that initially a temperature difference is produced between the temperature of the descender tube and the temperature of the flange plate, then the descender tube is inserted into the flange plate and, finally, temperature equilibrium is established between the descender tube and the flange plate, wherein a sealing press-fit connection between the descender tube and the flange plate is established. Accordingly, initially the temperature of the descender tube is a predetermined number of degrees lower than the temperature of the flange plate.

The production of such an adapter is considerably less complicated and also faster than by means of a welding process. Material combinations such as stainless steel and titanium are possible without any problems. Since no welding takes place, no lack of fusion can occur, so that inspection by specially trained personnel (welding procedure test) with the associated post treatment is not necessary. The temperatures occurring are considerably lower than in the case of welding, so that neither the descender tube nor the flange plate can be warped. Heat treatment, which might cause tarnishing, is also not necessary.

Using this process, it is possible to assemble several adapters per minute, while a welding time of 20 to 60 minutes is customary to weld a standard descender tube. It should be noted that the heating and cooling may take place without the assignment of personnel.

Preferably, the contact surface between the descender tube and the flange plate should be conically formed on the descender tube and the flange plate.

As the broader base of the cone lies on the system side, the adapter is suitable for systems with a prevailing overpressure.

In another embodiment of the adapter, the descender tube has a surrounding welded connection ring, which is sealingly fitted in the flange plate.

It is advantageous if the central recess of the flange plate has a joining diameter which is smaller by a predetermined amount than the joining diameter of the descender tube at temperature equilibrium of the two parts.

This predetermined amount is preferably 0.05 to 4.5 mm, particularly preferably 0.1 to 0.3 mm. This ensures that the connection is tight under helium testing.

In one development of the adapter, the flange plate and/or the descender tube has a joining stop.

It can be advantageous if the flange plate and the descender tube are made of different materials. This may even involve materials that cannot be joined together using welding processes.

It is particularly advantageous if a part of the adapter is made of stainless steel and/or Hastelloy and/or a nickel-based alloy and/or titanium and/or zirconium and/or steel that has been manufactured with an even higher strength.

Individual method steps are described in detail below. The steps need not necessarily be performed in the order presented, and the method to be outlined may also have further unspecified steps.

The task is further solved by a method for joining a two-part adapter to measure a physical state variable of a medium in a system. The method comprises the following steps:

1. Provision of a descender tube, wherein the descender tube is so designed that it is closed at one end; and that there is an opening at the other end through which it can receive a sensor in its interior.

2. Provision of a flange plate; wherein the flange plate has a central recess in which the descender tube is sealingly fitted in the flange plate.

3. Production of a temperature difference between the temperature of the descender tube and the temperature of the flange plate; wherein the temperature of the descender tube is lower by a predetermined number of degrees than the temperature of the flange plate.

4. Insertion of the descender tube in the flange plate.

5. Establishment of temperature equilibrium between the descender tube and the flange plate, wherein a sealing press-fit connection between the descender tube and the flange is obtained.

In the third step above, the flange plate is preferably heated to a temperature above 100° C., particularly preferably above 200° C., and very particularly preferably above 300° C.

Further details and features will become apparent from the following description of preferred embodiments in conjunction with the dependent claims. The respective characteristics may be implemented on their own or together in combination. The approaches to solving the task are not limited to the embodiments. For example, range specifications always comprise though not stated intermediate values and all conceivable subintervals.

The exemplary embodiments are shown schematically in the figures. The same reference numerals in the individual figures denote identical or functionally identical elements, which correspond in terms of their functions. Specifically:

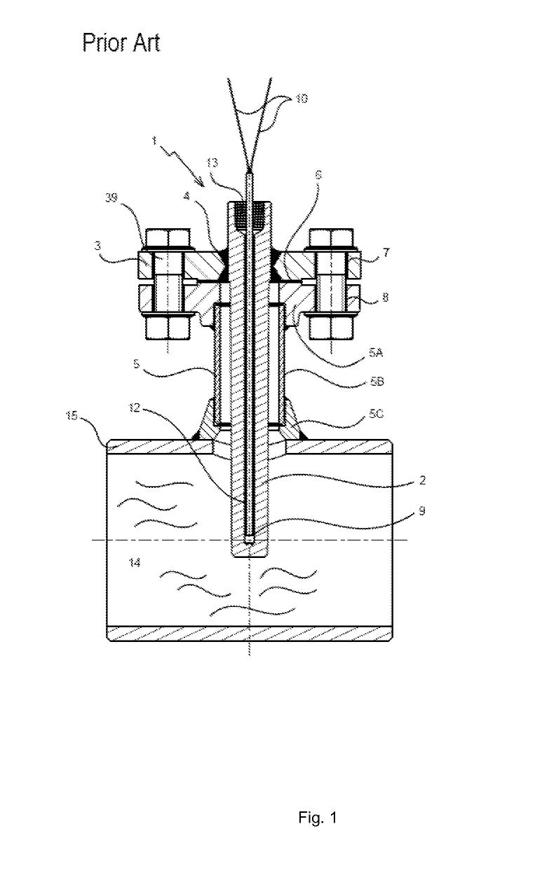

FIG. 1 shows a sectional view of an adapter according to the prior art;

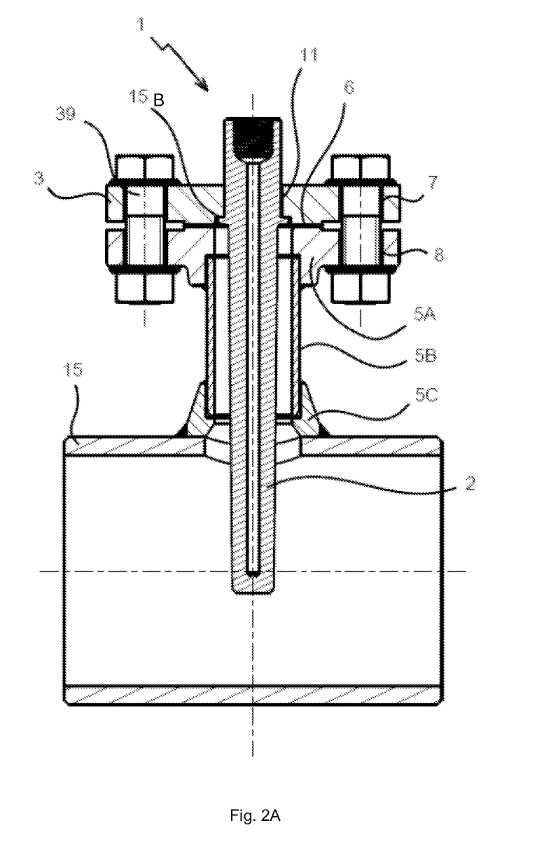

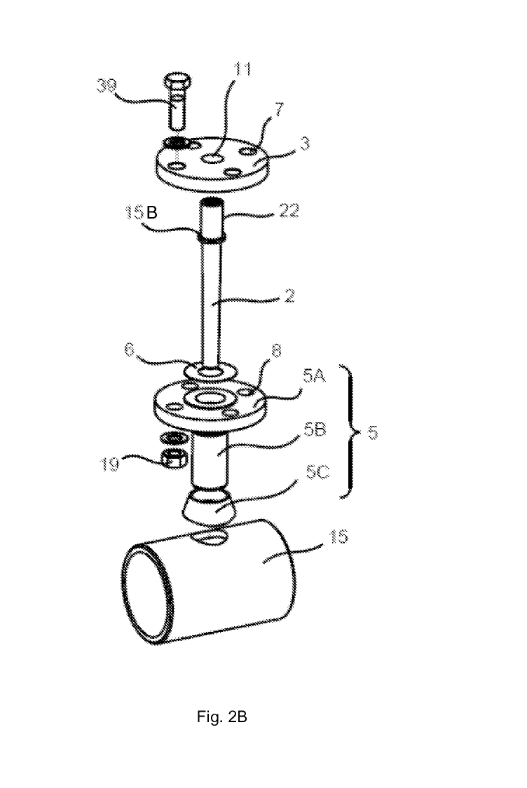

FIG. 2A shows a sectional view of an adapter according to the invention;

FIG. 2B shows an exploded view of the adapter of FIG. 2A;

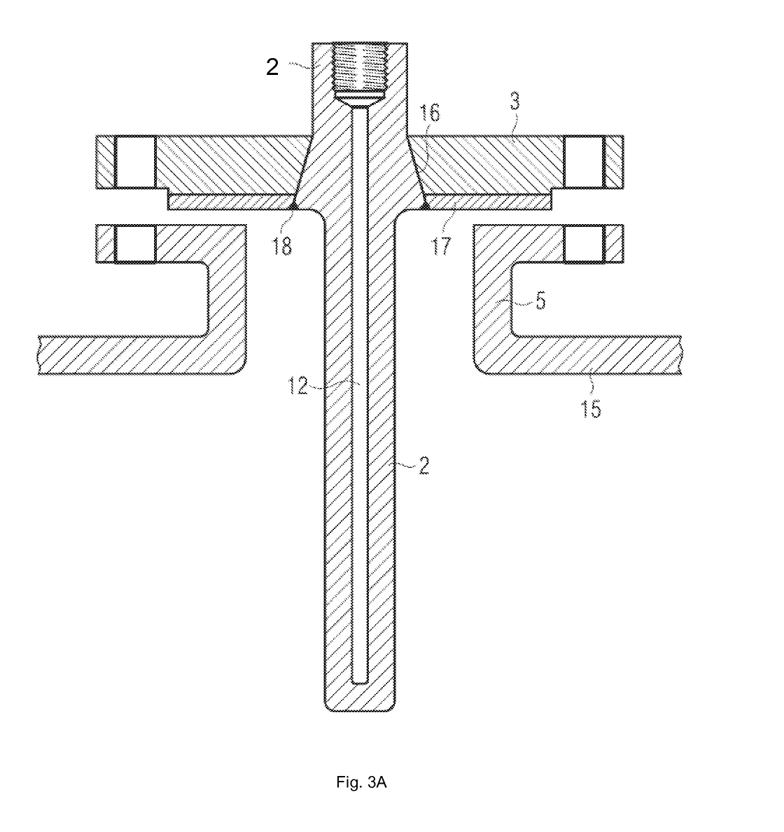

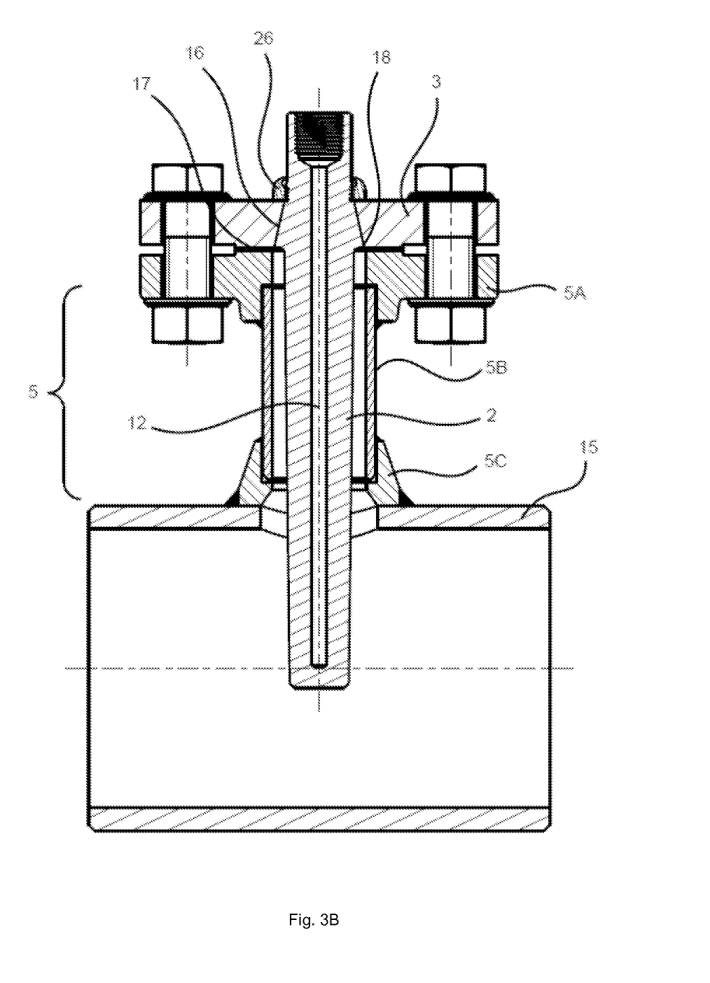

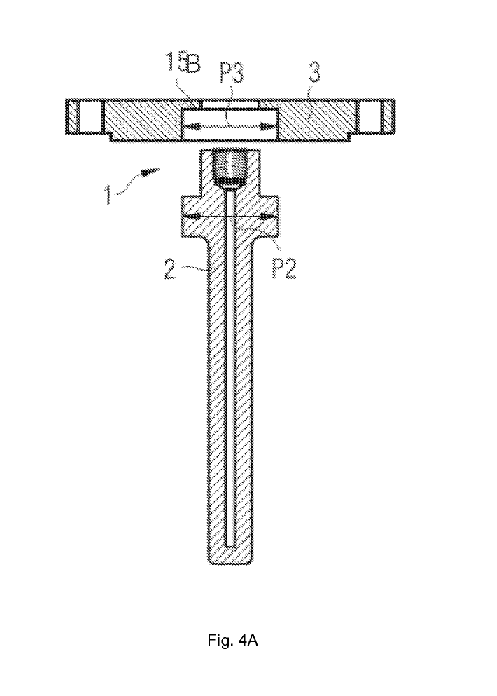

FIG. 3A shows a schematic sectional view of a further adapter according to the invention.

FIG. 3B shows a further sectional view of the adapter of FIG. 3A;

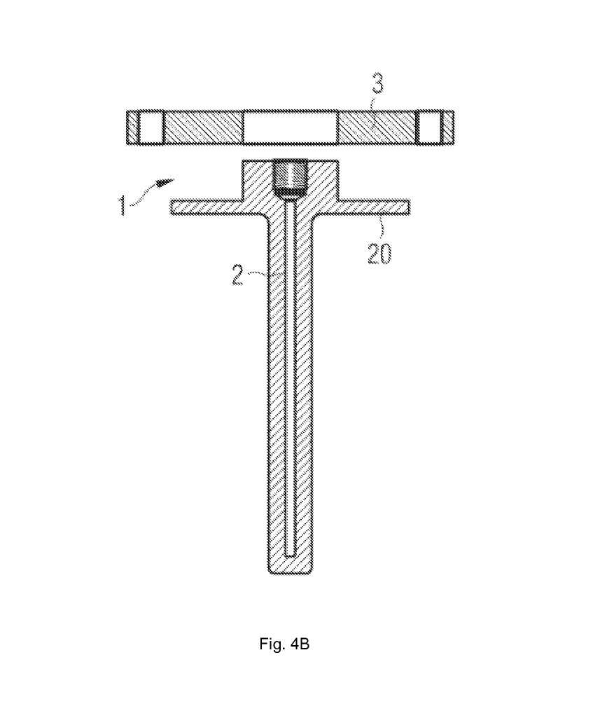

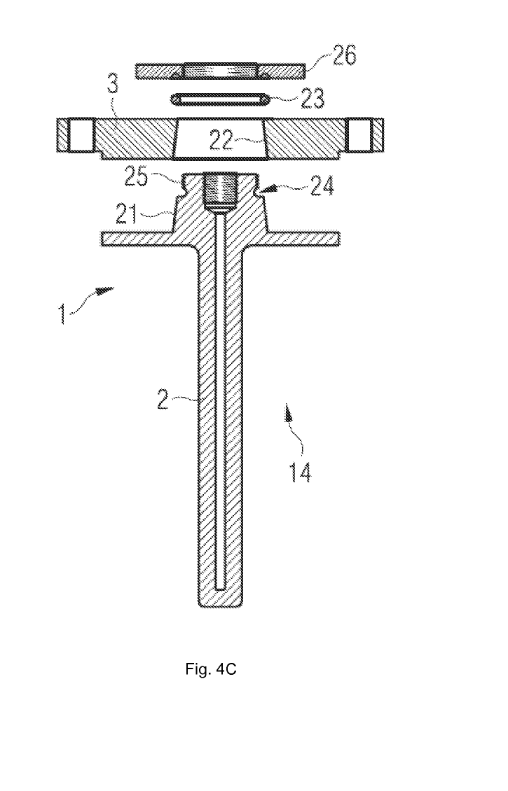

FIG. 4A shows a schematic sectional view of an adapter according to the invention with a stop.

FIG. 4B shows a schematic sectional view of a second adapter according to the invention with a stop;

FIG. 4C shows a schematic sectional view of a third adapter according to the invention with a stop;

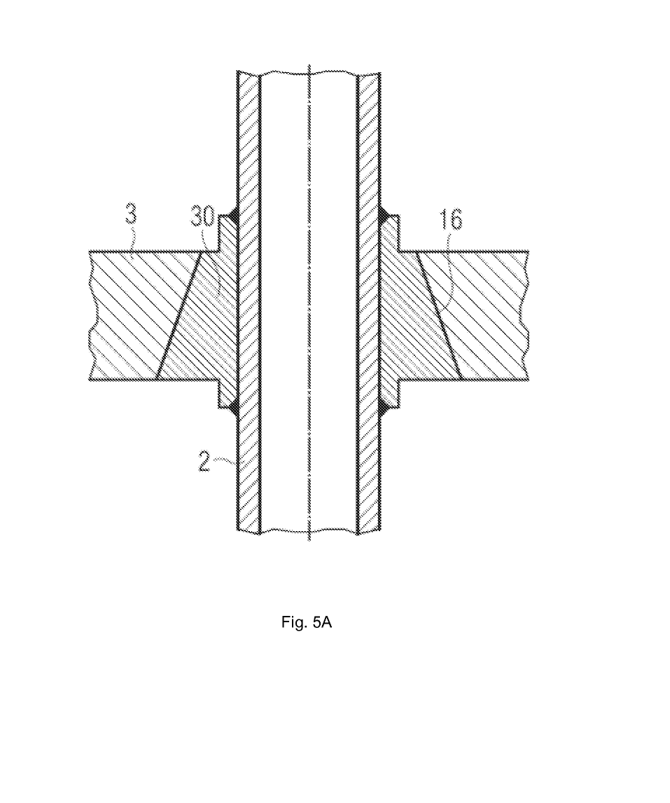

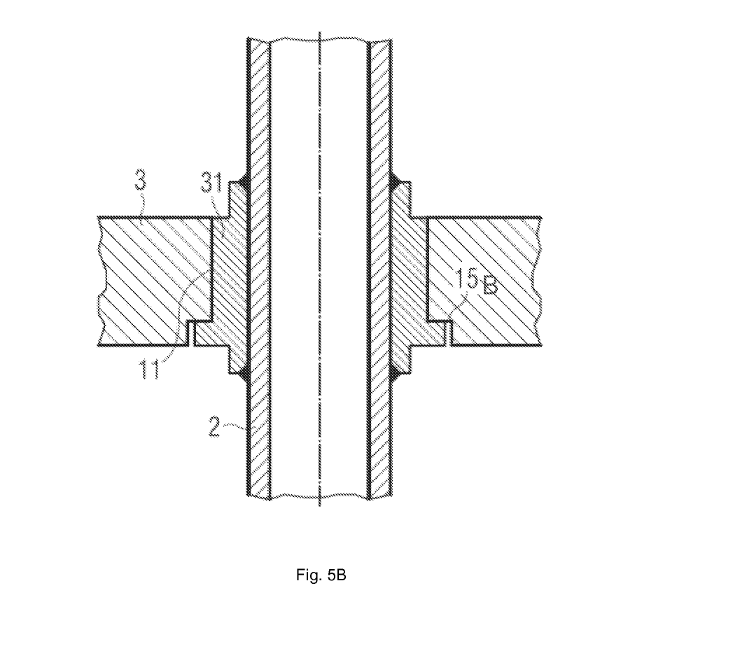

FIG. 5A shows a partial sectional view of an adapter according to the invention with a conical welded connection ring;

FIG. 5B shows a partial cross-sectional view of an adapter according to the invention with a cylindrical welded connection ring.

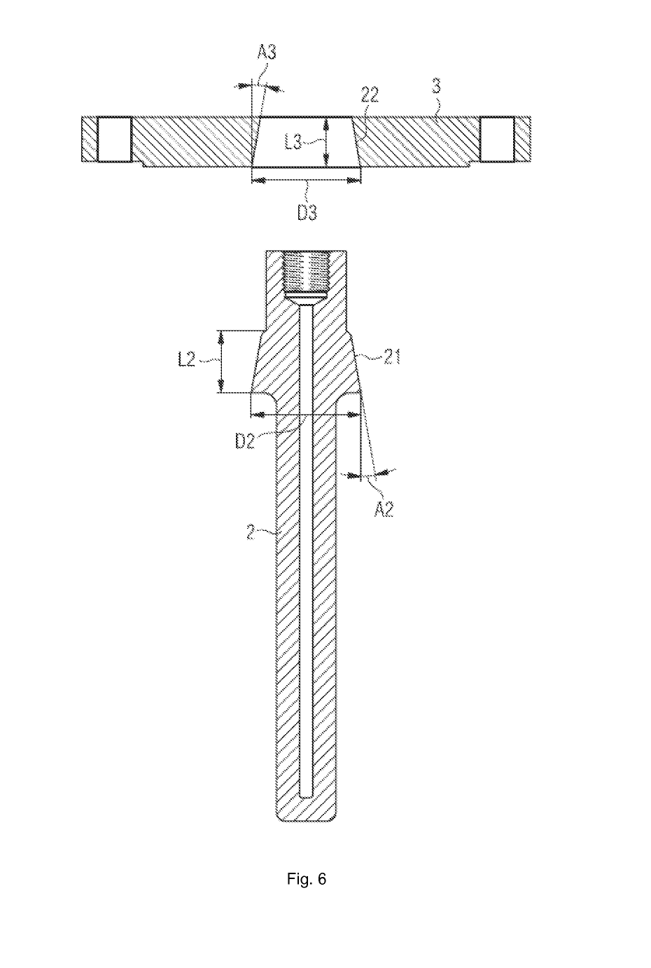

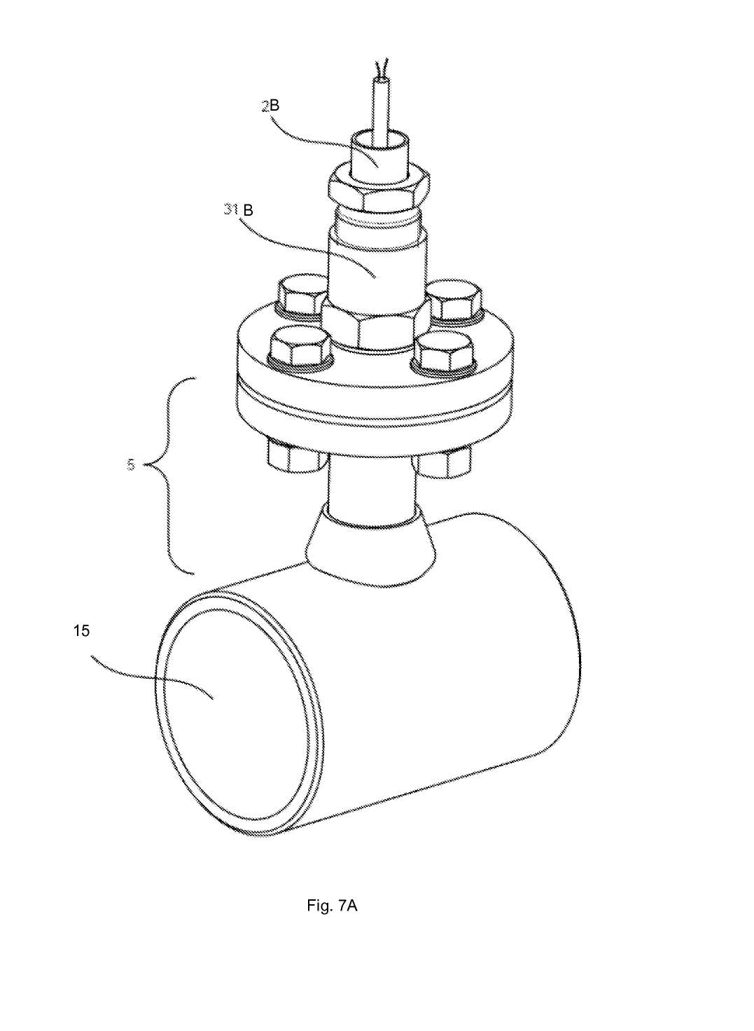

FIG. 6 shows a more detailed schematic sectional view of the joining zone of a conical adapter according to the invention;

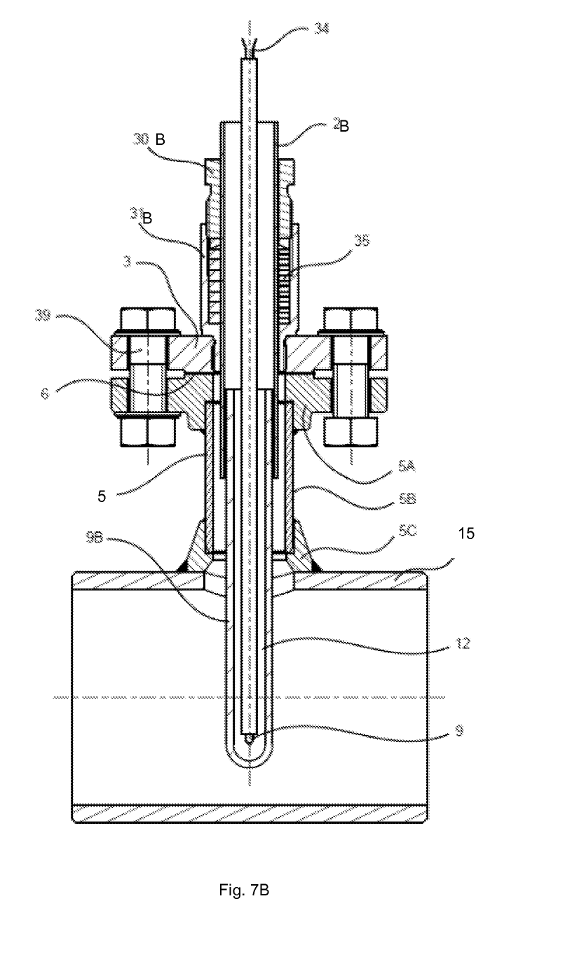

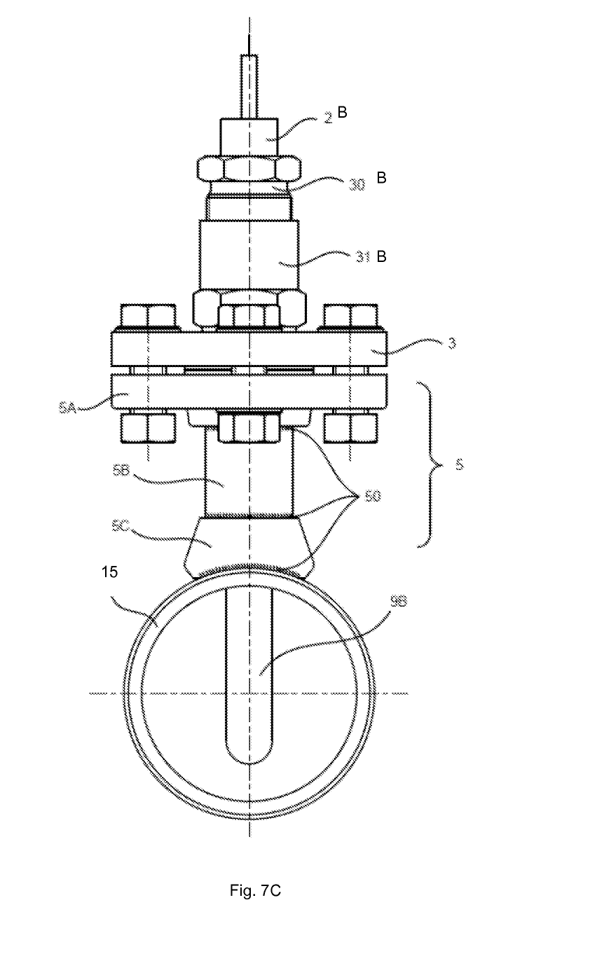

FIG. 7A shows an application example of a hot gas burner tube.

FIG. 7B shows a sectional view of the application example of FIG. 7A;

FIG. 7C shows a side view of the application example of FIG. 7A and B;

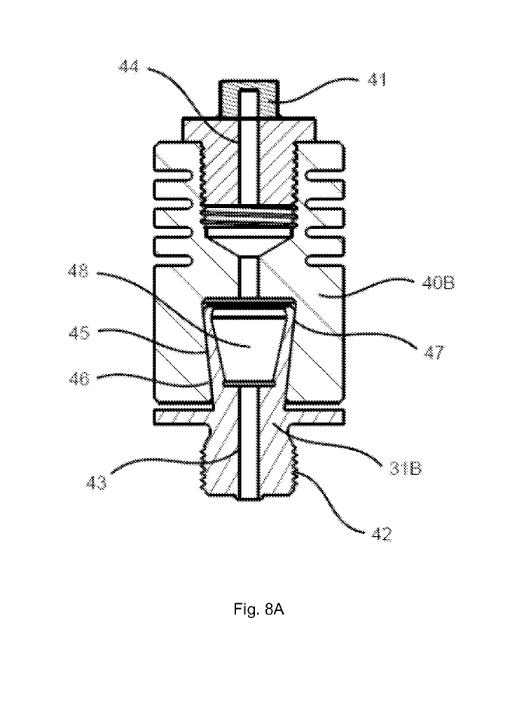

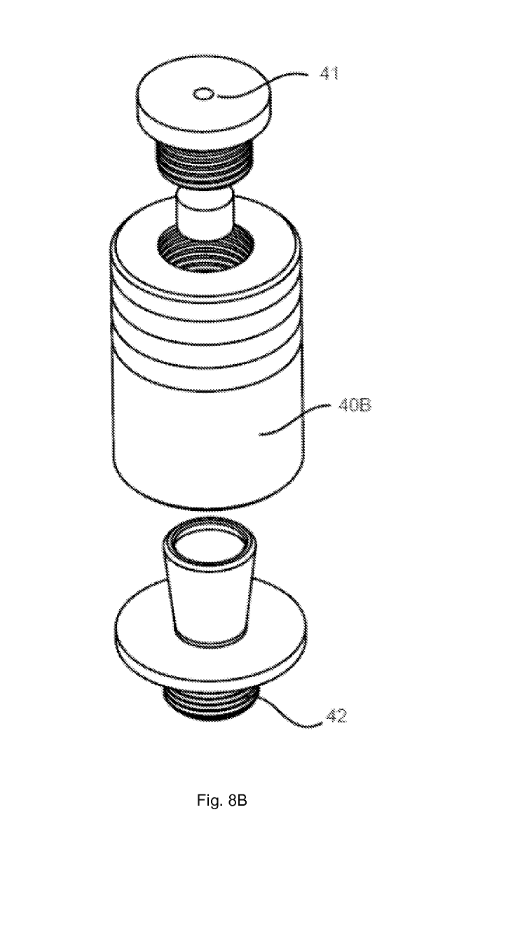

FIG. 8A shows a sectional view of another application example;

FIG. 8B shows an exploded view of the application example of FIG. 8A;

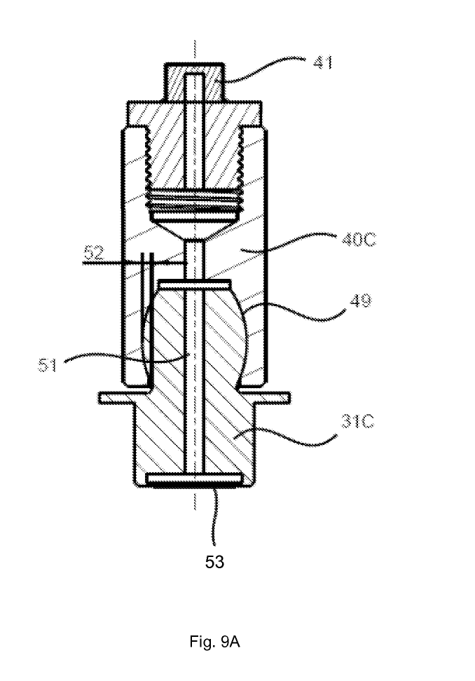

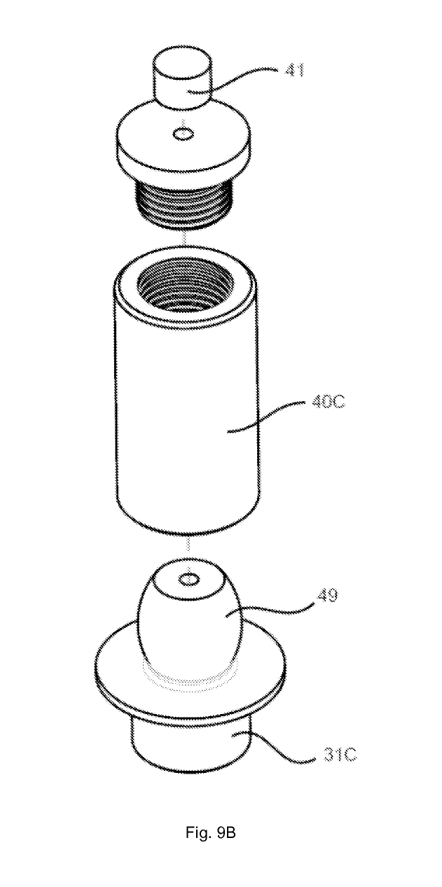

FIG. 9A shows a sectional view of a third application example; and

FIG. 9B shows an exploded view of the application example of FIG. 9A.

FIG. 1 shows the prior art in the form of a normal welded adapter 1, consisting of a descender tube 2 and the flange plate 3, wherein the descender tube 2 is joined to the flange plate and is welded, often in several circumferential passes, by welding 4 with the flange plate 3.

The finished adapter is then mounted in a connection opening 5. This consists, for example, of a flange plate 5A, which is sealingly connected to a system part 15 by an extension tube 5B, usually by means of a weld-on sleeve 5C.

Because of the complex welding, such adapters, so-called “full-pens” or “full penetration welding protection tubes” have indeed been market-tested, but are very expensive to manufacture due to long welding times. Furthermore, such structures are usually not central to one another and are therefore difficult or impossible to rotate.

After assembly to the connection opening 5 by means of a seal 6, the adapter 1, via the flange plate 3 by, for example, the joining and tightening of screws 39 in the holes 7 on the outer diameter of the flange plate, is sealed to the system, which has a flange hole geometry corresponding to the flange plate 3, with screw holes 8 to the flange plate 5A.

The descender tube 2 may then have a temperature sensor 9 in its central hole 12, which may be scanned as a thermocouple via the sensor connection wires 10 from the opening 13 facing away from the medium. Alternatively, a Pt100 sensor may be installed. The temperature of a liquid or gaseous medium 14 may thus be properly determined.

FIG. 2A shows an embodiment of the invention in section, while FIG. 2B shows a corresponding exploded view. The adapter 1 comprises a descender tube 2 and the flange plate 3. Both parts are sealingly connected together by “hot joining” on cylindrical bores. In this case, the flange plate 3 is manufactured first, wherein, in the manufacturing, the central hole 11 of the flange plate is “undersized” relative to the corresponding joining diameter of the descender tube 2. Then, the flange plate is heated, wherein the joint diameter 11 of the flange plate 3 expands by thermal expansion until the descender tube 2 with its joint 22 fits through the central hole 11 of the flange plate 3. The descender tube 2 is inserted up to a stop 15B. The resulting interference fit seals the two parts to one another on subsequent cooling, while also offering high mechanical strength, as in the case of a material connection, similar to a welding, but without the disadvantages encountered by the welding process, such as temperature increase, embrittlement or scaling. The flange plate 3 further includes mounting holes 7 in the outer region, with which the flange plate can be mounted over a connection opening 5 and an associated connection flange 5A with corresponding mounting holes 8 by means of screws 39 and nuts 19.

In this way, a detection system for a physical variable is created, wherein the adapter comprises two different parts, and wherein a sensor in the descender tube 2 may be brought as close as possible to the medium in a system 15 through a connection opening 5.

FIG. 3A shows another embodiment according to the invention, wherein the adapter 1 comprises a descender tube 2 and the flange plate 3 and both parts are joined together by “hot joining” on conical bores.

In this case, a flange protective plate 17 is connected to the descender tube 2 by a circumferential weld 18. On the one hand, this allows the descender tube and the flange protective plate to be appropriately made, on the side facing the system or the medium, for example, of the same material as the system part 15 with the connection opening 5. On the other hand, the flange plate 3 may then be made of a different material.

Thus it may be advantageous to make the descender tube 2 with the sensor hole 12 and the flange protective plate 17 of stainless steel, but to make the flange plate 3 of a steel with higher strength, for example A105.

FIG. 3B shows a similar embodiment to that of FIG. 3A, wherein the adapter consists of a descender tube 2 and the flange plate 3, and is mounted in a connection opening 5 for a tube 15, comprising the parts 5A, 5B, and 5C (the flange plate, extension tube, weld-on sleeve, as assembled in FIG. 2 A). In addition, the descender tube 2 is secured in the flange plate 3 with a nut 26.

FIG. 4A, 4B and 4C show adapters according to the invention, each of which has a stop.

In FIG. 4A, the adapter 1 consists of a descender tube 2 and the flange plate 3, wherein both parts have been assembled through “hot joining” by means of cylindrical joining bore fitting. In the design of the two parts with respect to one another for an interference fit, after joining under heating, the bore P3 is designed to have an oversize from 0.05 to 4.5 mm, preferably 0.1-0.3 mm, with respect to the joint bore P2 of the descender tube 2.

Thus a defined compression of the two joining diameters results, wherein this press-fit is relatively decoupled from the actual joining temperature, as long as it is ensured that the joining bore is sufficiently expanded through the heating of the flange plate 3 to allow the joining diameter of the descender tube to pass through, and a stop surface of the descender tube to be pushed against a stop 15B.

The tolerance of the compression operation is only to be taken into account insofar as the joining diameter is produced at various specified tolerances, and thus may cause some slight differences in the press fit.

FIG. 4B shows a further exemplary embodiment, wherein the adapter 1 comprises a descender tube 2 and the flange plate 3 and wherein both parts are joined to one another by means of “hot joining”, again by means of heating of the flange plate.

In this case, however, a plate 20 moulded onto the descender tube 2 forms the stop when joining the heated flange plate 3.

In the embodiment in FIG. 4C, the descender tube 2 and the flange plate 3 of the adapter 1 are joined to one another via their conical joining zones 21, 22 through “hot joining” by means of heating the flange plate 3. In particular, the conical shape ensures that in the event of an overpressure in the system, the descender tube 2 cannot be expelled outside under pressure. Leaks from the system at this point are therefore excluded.

In addition, the descender tube 2 may be secured by a snap clip 23 in a groove 24. Alternatively, it is possible to secure the descender tube 2 by a nut 26 which can be tightened on a threaded section 25 and/or additionally secured with a weld point.

FIG. 5A shows a solution wherein the descender tube 2 and the flange plate 3 are connected by “hot joining” by means of a conical connection ring 30, which has previously been welded to the sensor tube. Thus machining costs can be saved if the descender tube is manufactured from continuous or straight-length tubing. This can then be mounted on separate discs without any further cost by means of the conical joining zone 16.

FIG. 5B shows a variant wherein the connection ring is cylindrical with a cylindrical joining zone corresponding to the bore 11 in the flange plate, and a stop 15B.

FIG. 6 shows dimensional details in the use of conical joining zones: a conical zone 21 of the descender tube 2 is defined by a first largest diameter D2 over a length L2 at an angle A2; and the conical joining zone 22 of the flange plate 3 is defined by a second largest diameter of the cone D3 over a length L3 at an angle A3. If one now brings one of the two parts to a different temperature, for example, the flange plate 3 by heating, or the descender tube 2 by cooling, or one brings the temperatures of both parts to temperatures that are sufficiently apart from one another, then a very specific compression of the two parts with respect to one another is possible due to the conical joint surfaces and by very careful monitoring of the temperature of both parts with respect to one another. At the moment of joining, which is best achieved by insertion or hammering or a pulse burst, then both conical joining surfaces are driven down on one another without any tolerance. In this way, the compression results from the surface pressure on the diameters D2 and D3, respectively on the associated conical surfaces, due to the thermal expansion.

This has advantages compared to the use of cylindrical joining surfaces, which may only be manufactured to certain tolerance, and so may lead to slightly varying pressures on the diameters. Temperature control is particularly advantageous at 150-350° C., while, furthermore, the joining surfaces are self-locking as a result of a finishing method and by choosing the right angle, and therefore cannot slip when joining.

Alternatively, the joining may be effected by simultaneous pressing and rotating of the parts with respect to one another. In this case, both parts are heated until plasticisation, and then fuse with one another when the rotation is stopped.

An application example of a hot gas burner tube 15 is shown in FIG. 7A, B and C. FIG. 7A shows an external view. The sensor insert 2B is replaceable in a measuring adapter 31B, wherein they together form the descender tube.

The sectional view of FIG. 7B shows the connection opening 5 closed by means of the flange plate 3 with the aid of screws 39 and a seal 6. The measuring adapter 31B is inserted hot in the flange plate 3. A replaceable sensor rod 2B has a ceramic measuring insert 9B cemented in its peak, while the actual temperature sensor 9 lies right at the bottom of the bore 12 of the composite descender tube. Measuring wires 34 are led upwards and out. The temperature sensor insert 2B is sealingly fixed in the measuring adapter 31B by means of a screwed clamping cone 30B and/or additional sealing means such as a graphite string 35 in a threaded portion of the measuring adapter 31B.

In this way, constructions with quick-change probes are also possible.

The side view of FIG. 7C shows the three-part structure of the connection opening 5 of the above-described parts 5A-C together with the welds 50.

FIG. 8A shows another application example wherein a measuring adapter 31B with a thread 42 is sealingly connected to a system, and is tightly connected with a sensor base 40B by means of “hot joining”. A pressure-tight connection to a pressure sensor 41 may thus be produced through the central bores 43 and 44, wherein the pressure sensor 41 is sealingly applied or welded above the sensor base 40B. The sensor base 40B may have cooling fins. This structure represents a universal adapter for different sensors or different measuring adapters 31B with different threads 42, which may be combined as part of a modular system.

In particular, the joining surfaces may be cylindrical or conical, wherein various conical angle forms 45 and 46 of the parts may also be joined to one another. This leads to a sealing pressure of the two parts to one another at a circumferential edge 47. The sealing effect may be further enhanced by a toggle effect, which reinforces the sealing action of the parts to one another through a special bore geometry 48.

FIG. 8B shows the same application example in an exploded view.

FIG. 9A shows another application example wherein a measuring adapter 31C is sealingly connectable to a system and is provided with a sealing contact towards the system or the medium by a membrane 53, and is sealed to a sensor base 40C (as a variant of a flange plate) by means of “hot joining”. A hydraulic pressure connection to a pressure sensor 41 is produced through central bores, when the whole pressure path is filled with an isolating liquid 51 (typically oil).

All possible geometric shapes of the joining surfaces 49 of the two parts 31C and 40C are also conceivable, such as spherical surfaces, or calotte surfaces, or such as in FIG. 8A, with an undercut 52, which can be overcome by appropriate temperature control of the parts.

FIG. 9B shows the application example of FIG. 9A in an exploded view.

### GLOSSARY

### Stainless Steel

Stainless steel (according to EN 10020) is a designation for alloyed or unalloyed steels with special purity, for example, steels whose sulphur and phosphorus content (so-called iron contaminants) is not more than 0.025%. Colloquially, stainless steel is often equated with rustproof steel, but this is not correct.

### Flange

The use of flanges is a method of connecting tube sections with each other tightly but releasably (including air channels). The contact pressure of the annular sealing surfaces on the intermediate seal is decisive for the tightness. This is usually applied with screws, which are inserted through holes in the flange plates. Flanges are typically welded to the tube. They belong to the tube components (fittings). Flanges are often directly cast on fittings and gauges. (According to http://de.wikipedia.org/wiki/Flansch_(Rohrleitung))

### Flange Plate

Flange plate is used here to refer to a flange sheet (circular annular sealing surface, see flange), particularly for that part which is part of the adapter according to the invention.

### Hastelloy

Hastelloy is the brand name of a nickel-based alloy from Haynes International, Inc. The so-designated group of materials is resistant to many aggressive chemicals.

### NUMERAL REFERENCES

1 Adapter
2 Descender tube
2B Sensor insert
3 Flange plate
4 Welding
5 Connection opening
5A Connection flange
5B Extension tube
5C Weld-on sleeve
6 Seal
7 Bore
8 Screw hole
9 Temperature sensor
9B Ceramic measuring insert
10 Connection wire
11 Central bore of the flange plate
12 Central bore of the descender tube
13 Opening of the descender tube facing away from the medium
14 Medium
15 System part
15B Stop
16 Conical joining zone
17 Flange protective plate
18 Weld
19 Nut
20 Stop plate on the descender tube
21 Joint
22 Joint
23 Snap clip
24 Groove
25 Threaded section
26 Locknut
30 Connection ring, conical
30B Screwed clamping cone
31 Connection ring, cylindrical
31B Measuring adapter
31C Measuring adapter
34 Connection wire
35 Graphite cord
39 Screw
40B Sensor base
40C Sensor base
41 Pressure Sensor
42 Thread
43 Central bore
44 Central bore
45 Conical joining surface
46 Conical joining surface
47 Circumferential edge
48 Bore geometry with toggle effect
49 Joining surfaces
50 Weld
51 Isolating liquid
52 Undercut of the joint surface shape
53 Membrane
A2 Conical angle of the joining zone of the descender tube
A3 Conical angle of the joining zone of the flange plate
D2 Greatest diameter of the joining zone of the descender tube
D3 Greatest diameter of the joining zone of the flange plate
L2 Length of the joining zone of the descender tube
L3 Length of the joining zone of the flange plate
P2 Joining diameter of the descender tube
P3 Joining diameter of the flange plate

1. Adapter for measuring a physical state variable of a medium in a system by a sensor;
1.1 wherein the system has an opening;
1.2 wherein the opening has a connection flange for closing the opening;
1.3 wherein the connection flange has a central recess; with
1.4 a descender tube wherein the descender tube is so designed,
1.4.1 that it can be inserted into the medium through the central recess and the opening;
1.4.2 that it is closed towards the medium;
1.4.3 that it has an opening on the side facing away from the medium, through which it can receive the sensor in its interior; and with
1.5 a flange plate which can be sealingly connected to the connection flange;
1.5.1 wherein the flange plate has a central recess, in which the descender tube can be sealingly fitted in the flange plate;
characterised in that,
1.6 the sealing fitting of the descender tube in the flange plate is configured as a press-fit connection.

2. Adapter according to claim 1, wherein
the contact surface between the descender tube and the flange plate to the descender tube and the flange plate is conical.

3. Adapter according to claim 2, wherein
the broader base of the cone is formed on the system side

4. Adapter according to claim 1, wherein the press-fit connection was achieved by,
4.1 initially establishing a temperature difference between the temperature of the descender tube and the temperature of the flange plate;
4.2 adjusting the temperature of the descender tube to be lower by a predetermined number of degrees than the temperature of the flange plate;
4.3 then inserting the descender tube into the flange plate; and
4.4 then establishing temperature equilibrium between the descender tube and the flange plate in order to obtain a sealing press-fit connection between the descender tube and the flange plate.

5. Adapter according to claim 1, wherein
the descender tube has a welded, peripheral connection ring, which is sealingly fitted in the flange plate.

6. Adapter according to claim 4, wherein
the central recess of the flange plate has a joining diameter, which, at temperature equilibrium of the two parts, is smaller than the joining diameter of the descender tube by a predetermined amount.

7. Adapter according to claim 6, wherein
the predetermined amount is from 0.05 to 4.5 mm, preferably 0.1 to 0.3 mm.

8. Adapter according to claim 1, wherein
the flange plate and/or the descender tube has a joining stop.

9. Adapter according to claim 1, wherein
the flange plate and the descender tube are made of different materials.

10. Adapter according to claim 1, wherein
a part of the adapter is made of stainless steel and/or Hastelloy and/or a nickel-based alloy and/or titanium and/or zirconium and/or steel manufactured with an even higher strength.

11. Method for assembling a two-piece adapter for measuring a physical state variable of a medium in a system comprising the steps of:
11.1 providing a descender tube, wherein the descender tube is so designed
11.1.1 that it is closed at one end; and
11.1.2 has an opening at the other end through which it can receive a sensor in its interior;
11.2 providing a flange plate;
11.2.1 wherein the flange plate has a central recess, in which the descender tube is sealingly fitted in the flange plate;
11.3 establishing a temperature difference between the temperature of the descender tube (2) and the temperature of the flange plate:
11.3.1 wherein the temperature of the descender tube is lower by a predetermined number of degrees than the temperature of the flange plate;
11.4 inserting the descender tube in the flange plate; and
11.5 establishing temperature equilibrium between the descender tube and the flange plate in order to form a sealing press-fit connection between the descender tube and the flange plate.

12. Method according to claim 11, wherein in step 11.3, the flange plate is heated to a temperature above 100° C., preferably above 200° C., preferably above 300° C.

13. Adapter for measuring a physical state variable of a medium in a system by a sensor;
13.1 wherein the system has an opening;
13.2 wherein the opening has a first thread;
with
13.3 a measuring adapter with a second thread by means of which the measuring adapter is sealingly connected to the system by being screwed into the first thread;
13.4 a sensor base;
13.5 wherein the measuring adapter and the sensor base have communicating central holes; and with
13.6 a sensor which is sealingly mounted to the sensor base;
characterised in that,
13.7 the measuring adapter is sealingly fitted in the sensor base;
13.8 the joining surfaces between the measuring adapter and the sensor base are undercut;
13.9 the sealing fitting of the measuring adapter in the sensor base was achieved by
13.9.1 initially establishing a temperature difference between the temperature of the measuring adapter and the temperature of the sensor base.
13.9.2 adjusting the temperature of the measurement adapter to be lower by a predetermined number of degrees than the temperature of the sensor base
13.9.3 then inserting the measuring adapter into the sensor base; and
13.9.4 then establishing temperature equilibrium between the measuring adapter and the sensor base in order to obtain a sealing press-fit connection between the measuring adapter and the sensor base.
